(19) United States
(12) Patent Application Publication
(10) Pub. No.: US 2008/0114115 A1
(43) Pub. Date: May 15, 2008

(54) Composition for forming coating and coating formed of composition

(75) Inventors: Hiroyuki Iida, Kawasaki-shi (JP); Hideya Kobari, Kawasaki-shi (JP)

Correspondence Address: HARNESS, DICKEY & PIERCE, P.L.C., P.O. BOX 8910, RESTON, VA, 20195, US

(73) Assignee: TOKYO OHKA KOGYO CO., LTD

(21) Appl. No.: 11/979,434

(22) Filed: Nov. 2, 2007

(30) Foreign Application Priority Data
Nov. 10, 2006 (JP) 2006-305978

(51) Int. Cl. C08K 3/08; C08L 83/04

(52) U.S. Cl. 524/439

(57) ABSTRACT

A composition for forming a coating in accordance with the present invention includes a siloxane polymer obtained by hydrolyzing and condensing a silane compound containing an alkoxysilane compound represented by general formula (1) below

R¹ₙSi(OR²)₄₋ₙ (1)

(where R¹ represents an organic group having 1 to 20 carbon atoms, R² represents an alkyl group having 1 to 4 carbon atoms, and n represents either 1 or 2).

A molar fraction of the alkoxysilane compound, represented by general formula (1), in the silane compound is 0.5 or above. The foregoing realizes a composition for forming a coating, which composition allows formation of a silica base coating that is lowered in dielectric constant and improved in mechanical strength and electric properties.

This Nonprovisional application claims priority under 35 U.S.C. § 119(a) on Patent Application No. 305978/2006 filed in Japan on Nov. 10, 2006, the entire contents of which are hereby incorporated by reference.

### FIELD OF THE INVENTION

The present invention relates to a composition for forming a coating, which composition allows formation of a silica base coating that is to be used as interlayer insulating films of semiconductor devices. The present invention also relates to a coating made of the composition.

### BACKGROUND OF THE INVENTION

Conventionally, silica base coatings have been popularly used as planarizing films and interlayer insulating films of semiconductor devices such as LSI. The silica base coatings are generally formed by CVD or spin-coating. Especially the spin-coating is popularly employed to form the silica base coatings, as this method is convenient.

Further, there have been increasing demands for higher packaging density of semiconductor devices such as LSI. As the wirings become finer as a result of increase in packaging density, however, the capacity of the wirings increases, and there arises a problem of increase in signal delay time. In view of solving the problem, a composition that allows formation of a silica base coating with low dielectric constant has been demanded.

A technique for forming a silica base coating with low dielectric constant is disclosed in Japanese Unexamined Patent Publication No. 2002-201415 (publication date: Jul. 19, 2002). Specifically, a pyrolysis volatile organic polymer for making porosity is added to form a silica base coating so that the silica base coating thus formed becomes porous.

Further, Japanese Unexamined Patent Publication No. 2004-356508 (publication date: Dec. 16, 2004) discloses a method of forming a silica base coating, which method includes forming holes by irradiating ultraviolet rays to a silica base coating made of a composition that is robust in skeleton structure, or enlarging the size of holes that are formed, thereby reducing dielectric constant and improving mechanical strength.

However, if holes are made in the silica base coating to make the coating porous as disclosed in JP 2002-201415, the mechanical strength of the whole coating decreases significantly. This causes a problem of breakage of the silica base coating during CMP (Chemical Mechanical Polishing), which is carried out to planarize the silica base coating that is formed, and during packaging.

Further, according to a semiconductor roadmap advocated by the Ministry of Economy, Trade and Industry, an interlayer insulating film with a dielectric constant of 2.5 or lower in a semiconductor device with a line width of 60 nm is demanded. However, the dielectric constant of the silica base coating obtainable by the method described in JP 2004-356508 is approximately 2.4 to 2.6. Therefore, it is necessary to develop a silica base coating that is further lowered in dielectric constant, as the interlayer insulating films are demanded to have lower dielectric constant in the coming years. The silica base coatings used as the interlayer insulating films of the semiconductor devices are also demanded not only to be reduced in dielectric constant and to improve in mechanical strength but also to have excellent electric properties.

The present invention is in view of the above problems, and has as an object to provide a composition for forming a coating, and a coating made of the composition, which composition allows formation of a silica base coating that has lower dielectric constant, improved mechanical strength, and improved electric properties.

### SUMMARY OF THE INVENTION

As described earlier, if a void content or the size of holes formed in the silica base coating is reduced to improve the mechanical strength, the dielectric constant cannot be reduced to a desired level. Further, also as described earlier, if the void content or the size of the holes is increased to lower the dielectric constant, the mechanical strength of the silica base coating decreases significantly.

The inventors of the present invention have considered that adjustment of a molar fraction of an alkoxysilane compound (the alkoxysilane compound will be simply referred to as alkoxysilane compound hereinafter) that is represented by general formula (1) below and contained in a silane compound utilized to form a siloxane polymer makes it possible to produce a silica base coating that is lowered in dielectric constant and improved in mechanical strength

R¹ₙSi(OR²)₄₋ₙ (1)

(where R¹ represents an organic group having 1 to 20 carbon atoms, R² represents an alkyl group having 1 to 4 carbon atoms, and n represents either 1 or 2).

To solve the above problems, the inventors of the present invention have diligently studied. As a result, the inventors have found that, if the molar fraction of the alkoxysilane compound in the silane compound utilized to form the siloxane polymer is 0.5 or above, more preferably in the range of 0.5 to 0.9, it becomes possible to form a silica base coating that is low in dielectric constant and is improved in mechanical strength, thereby completing the present invention. Further, with the silica base coating, it is possible to improve the electric properties.

It can also be said that a feature of the present invention is that a molar fraction of Si combined with the organic group is 0.5 or above, more preferably in the range of 0.5 to 0.9, with respect to all silicon constituting the siloxane polymer.

The present invention is completed on the basis of the new findings, and includes the following invention.

A composition for forming a coating in accordance with the present invention is adapted so that the composition contains a siloxane polymer obtained by hydrolyzing and condensing a silane compound containing the alkoxysilane compound represented by general formula (1) below, and the molar fraction of the alkoxysilane compound that is represented by general formula (1) and contained in the silane compound is 0.5 or above

R¹ₙSi(OR²)₄₋ₙ (1)

(where R¹ represents an organic group having 1 to 20 carbon atoms, R² represents an alkyl group having 1 to 4 carbon atoms, and n represents either 1 or 2).

Further, a composition for forming a coating in accordance with the present invention is adapted so that the composition contains a siloxane polymer obtained by hydrolyzing and condensing a silane compound containing the alkoxysilane compound represented by general formula (1), and the molar fraction of Si combined with the organic group is 0.5 or above with respect to all silicon constituting the siloxane polymer

R¹ₙSi(OR²)₄₋ₙ (1)

(where R¹ represents an organic group having 1 to 20 carbon atoms, R² represents an alkyl group having 1 to 4 carbon atoms, and n represents an integer in the range of 1 to 2).

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a graph showing proportions of Examples 1 and 2 with respect to Comparative Examples 2 and 3, respectively, in dielectric constant and modulus of elasticity.

### DESCRIPTION OF THE EMBODIMENTS

### Embodiment 1

The following describes a composition for forming a coating in accordance with an embodiment of the present invention. The composition of the present embodiment contains a siloxane polymer obtained by hydrolyzing a silane compound containing an alkoxysilane compound and condensing the silane compound.

The present embodiment first discusses the siloxane polymer and the silane compound utilized to obtain the siloxane polymer, and then discusses hydrolysis and condensation that are carried out to obtain the siloxane polymer. The rest of the components of the composition other than the siloxane polymer will be discussed at the end.

(Siloxane Polymer)

In the present Specification, the “siloxane polymer” contained in the composition for forming a coating is a polymer having a Si—O unit as its skeleton. In the present embodiment, the siloxane polymer is obtainable by hydrolyzing and condensing a silane compound.

The mass-average molecular weight (Mw) (by Gel Permeation Chromatography (GPC) using polystyrene as a reference) of the siloxane polymer is not particularly limited, but it is preferable that the mass-average molecular weight be in the range of 1,000 to 10,000, and more preferably in the range of 1,000 to 5,000.

Further, it is preferable that a concentration of the siloxane polymer in the composition be in the range of 0.1 to 20% by weight, more preferably in the range of 0.5 to 10% by weight. If the concentration of the siloxane polymer in the composition is in the range above, it is easy to form a silica base coating having a thickness suitable to be used as the interlayer insulating films of the semiconductor devices. Production of the composition is also facilitated.

(Tetraalkoxysilane)

The following describes tetraalkoxysilane, which is a kind of the silane compound utilized to obtain the siloxane polymer. In the present Specification, the tetraalkoxysilane is classified into a different category from the alkoxysilane compound.

Preferably, the tetraalkoxysilane in the present embodiment has the structure represented by general formula (2) below

Si(OR³)₄ (2)

(where R³ independently represents an alkyl group having 1 to 4 carbon atoms).

The alkyl group represented by R³ in general formula (2) may be in either of a straight-chain shape and a branched-chain shape, as long as it is an alkyl group having 1 to 4 carbon atoms. Concrete examples of the alkyl group having 1 to 4 carbon atoms include a methyl group, an ethyl group, an n-propyl group, an isopropyl group, an n-butyl group, a sec-butyl group, and a tert-butyl group.

Examples of the tetraalkoxysilane represented by general formula (2) include tetramethoxysilane, tetraethoxysilane, tetra-n-propoxysilane, tetra-isopropoxysilane, tetra-n-butoxysilane, tetra-sec-butoxysilane, and tetra-tert-butoxysilane. Among those listed above, tetramethoxysilane, tetraethoxysilane, tetra-isopropoxysilane, and tetra-n-butoxysilane are preferable, and tetramethoxysilane and tetraethoxysilane are more preferable, in view of easiness in controlling during the hydrolysis and condensation.

(Alkoxysilane Compound)

The following describes the alkoxysilane compound, which is a kind of the silane compound utilized to obtain the siloxane polymer.

The alkoxysilane compound of the present invention has the structure represented by general formula (1) below

R¹ₙSi(OR²)₄₋ₙ (1)

(where R¹ represents an organic group having 1 to 20 carbon atoms, R² represents an alkyl group having 1 to 4 carbon atoms, and n represents either 1 or 2).

In the present embodiment, the alkoxysilane compound may be a trialkoxysilane compound, a dialkoxysilane compound, or a mixture of the trialkoxysilane compound and the dialkoxysilane compound. If the alkoxysilane compound is to be either the trialkoxysilane compound or the dialkoxysilane compound, the trialkoxysilane compound is preferable. The trialkoxysilane compound and the dialkoxysilane compound are described below.

(Trialkoxysilane Compound)

The following describes the trialkoxysilane compound.

The trialkoxysilane compound is a compound represented by general formula (1) above where n is 1. The trialkoxysilane compound has the structure represented by general formula (3) below

R⁴Si(OR⁵)₃ (3)

(where R⁴ represents an organic group having 1 to 20 carbon atoms, and R⁵ independently represents an alkyl group having 1 to 4 carbon atoms).

The organic group having 1 to 20 carbon atoms and represented by R⁴ in general formula (3) is not particularly limited. Examples of the organic group include: an alkyl group such as a methyl group, an ethyl group, and a propyl group; an alkenyl group such as a vinyl group, an allyl group, and a propenyl group; an aryl group such as a phenyl group and a tolyl group; and an aralkyl group such as a benzyl group and a phenylethyl group. The organic group may contain a substituent such as an epoxy-containing group, including a glycidyl group and a glycidyloxy group, and an amino-containing group, including an amino group and an alkylamino group. Among those listed above, it is preferable that R⁴ be an organic group having 1 to 6 carbon atoms, more preferably an alkyl group having 1 to 6 carbon atoms. Concretely, it is preferable that R⁴ be a methyl group, an ethyl group, a propyl group, a phenyl group or the like.

In the same manner as R³ of the tetraalkoxysilane discussed above, the alkyl group represented by R⁵ may be in either of a straight-chain shape and a branched-chain shape, as long as it is an alkyl group having 1 to 4 carbon atoms. Concrete examples of the alkyl group include a methyl group, an ethyl group, an n-propyl group, an isopropyl group, an n-butyl group, a sec-butyl group, and a tert-butyl group. Among those listed above, the methyl group, the ethyl group, the isopropyl group, and the n-butyl group are preferable in view of easiness in controlling during the hydrolysis and condensation.

Examples of the trialkoxysilane compound represented by general formula (3) include methyltrimethoxysilane, methyltriethoxysilane, methyltri-n-propoxysilane, methyltri-isopropoxysilane, methyltri-n-butoxysilane, methyltri-sec-butoxysilane, methyltri-tert-butoxysilane, ethyltrimethoxysilane, ethyltriethoxysilane, ethyltri-n-propoxysilane, ethyltri-isopropoxysilane, ethyltri-n-butoxysilane, ethyltri-sec-butoxysilane, ethyltri-tert-butoxysilane, vinyltrimethoxysilane, vinyltriethoxysilane, vinyltri-n-propoxysilane, vinyltri-isopropoxysilane, vinyltri-n-butoxysilane, vinyltri-sec-butoxysilane, vinyltri-tert-butoxysilane, n-propyltrimethoxysilane, n-propyltriethoxysilane, n-propyltri-n-propoxysilane, n-propyltri-isopropoxysilane, n-propyltri-n-butoxysilane, n-propyltri-sec-butoxysilane, n-propyltri-tert-butoxysilane, isopropyltrimethoxysilane, isopropyltriethoxysilane, isopropyltri-n-propoxysilane, isopropyltri-isopropoxysilane, isopropyltri-n-butoxysilane, isopropyltri-sec-butoxysilane, isopropyltri-tert-butoxysilane, n-butyltrimethoxysilane, n-butyltriethoxysilane, n-butyltri-n-propoxysilane, n-butyltri-isopropoxysilane, n-butyltri-n-butoxysilane, n-butyltri-sec-butoxysilane, n-butyltri-tert-butoxysilane, sec-butyltrimethoxysilane, sec-butyl-isotriethoxysilane, sec-butyltri-n-propoxysilane, sec-butyltri-isopropoxysilane, sec-butyltri-n-butoxysilane, sec-butyltri-sec-butoxysilane, sec-butyltri-tert-butoxysilane, tert-butyltrimethoxysilane, tert-butyltriethoxysilane, tert-butyltri-n-propoxysilane, tert-butyltri-isopropoxysilane, tert-butyltri-n-butoxysilane, tert-butyltri-sec-butoxysilane, tert-butyltri-tert-butoxysilane, phenyltrimethoxysilane, phenyltriethoxysilane, phenyltri-n-propoxysilane, phenyltri-isopropoxysilane, phenyltri-n-butoxysilane, phenyltri-sec-butoxysilane, phenyltri-tert-butoxysilane, vinyltrimethoxysilane, vinyltriethoxysilane, γ-aminopropyltrimethoxysilane, γ-aminopropyltriethoxysilane, γ-glycidoxypropyltrimethoxysilane, γ-glycidoxypropyltriethoxysilane, γ-trifluoropropyltrimethoxysilane, γ-trifluoropropyltriethoxysilane, divinyltrimethoxysilane, γ-aminopropyltrimethoxysilane, γ-aminopropyltriethoxysilane, γ-glycidoxypropyltrimethoxysilane, γ-glycidoxypropyltriethoxysilane, γ-trifluoropropyltrimethoxysilane, and γ-trifluoropropyltriethoxysilane, to name a few.

Among those listed above, the following are preferable: methyltrimethoxysilane, methyltriethoxysilane, methyltri-isopropoxysilane, methyltri-n-butoxysilane, ethyltrimethoxysilane, ethyltriethoxysilane, ethyltri-isopropoxysilane, ethyltri-n-butoxysilane, n-propyltrimethoxysilane, n-propyltriethoxysilane, n-propyltri-isopropoxysilane, n-propyltri-n-butoxysilane, isopropyltrimethoxysilane, isopropyltriethoxysilane, isopropyltri-isopropoxysilane, isopropyltri-n-butoxysilane, phenyltrimethoxysilane, and phenyltriethoxysilane.

(Dialkoxysilane Compound)

The following describes the dialkoxysilane compound.

The dialkoxysilane compound is the compound represented by general formula (1) above where n is 2. The dialkoxysilane compound has the structure represented by general formula (4) below

R⁶₂Si(OR⁷)₂ (4)

(where R⁶ independently represents an organic group having 1 to 20 carbon atoms, and R⁷ independently represents an alkyl group having 1 to 4 carbon atoms).

The organic group having 1 to 20 carbon atoms and represented by R⁶ in general formula (4) is same as R⁴ of the trialkoxysilane compound. Concretely, a methyl group, an ethyl group, a propyl group, and a phenyl group are preferable. The methyl group, the ethyl group, and the propyl group are more preferable. It is preferable that the dialkoxysilane compound be a dialkyldialkoxysilane compound.

In the same manner as R³ of the tetraalkylalkoxysilane and R⁵ of the trialkoxysilane compound discussed above, the alkyl group represented by R⁷ may be in either of a straight-chain shape and a branched-chain shape, as long as it is an alkyl group having 1 to 4 carbon atoms. Concrete examples of the alkyl group include a methyl group, an ethyl group, an n-propyl group, an isopropyl group, an n-butyl group, a sec-butyl group, and a tert-butyl group. Among those listed above, the methyl group, the ethyl group, the isopropyl group, and the n-butyl group are preferable in view of easiness in controlling during the hydrolysis and condensation.

Examples of the dialkoxysilane compound represented by general formula (4) include dimethyldimethoxysilane, dimethyldiethoxysilane, dimethyl-di-n-propoxysilane, dimethyl-di-isopropoxysilane, dimethyl-di-n-butoxysilane, dimethyl-di-sec-butoxysilane, dimethyl-di-tert-butoxysilane, diethyldimethoxysilane, diethyldiethoxysilane, diethyl-di-n-propoxysilane, diethyl-di-isopropoxysilane, diethyl-di-n-butoxysilane, diethyl-di-sec-butoxysilane, diethyl-di-tert-butoxysilane, di-n-propyldimethoxysilane, di-n-propyldiethoxysilane, di-n-propyl-di-n-propoxysilane, di-n-propyl-di-isopropoxysilane, di-n-propyl-di-n-butoxysilane, di-n-propyl-di-sec-butoxysilane, di-n-propyl-di-tert-butoxysilane, di-isopropyldimethoxysilane, di-isopropyldiethoxysilane, di-isopropyl-di-n-propoxysilane, di-isopropyl-di-isopropoxysilane, di-isopropyl-di-n-butoxysilane, di-isopropyl-di-sec-butoxysilane, di-isopropyl-di-tert-butoxysilane, di-n-butyldimethoxysilane, di-n-butyldiethoxysilane, di-n-butyl-di-n-propoxysilane, di-n-butyl-di-isopropoxysilane, di-n-butyl-di-n-butoxysilane, di-n-butyl-di-sec-butoxysilane, di-n-butyl-di-tert-butoxysilane, di-sec-butyldimethoxysilane, di-sec-butyldiethoxysilane, di-sec-butyl-di-n-propoxysilane, di-sec-butyl-di-isopropoxysilane, di-sec-butyl-di-n-butoxysilane, di-sec-butyl-di-sec-butoxysilane, di-sec-butyl-di-tert-butoxysilane, di-tert-butyldimethoxysilane, di-tert-butyldiethoxysilane, di-tert-butyl-di-n-propoxysilane, di-tert-butyl-di-isopropoxysilane, di-tert-butyl-di-n-butoxysilane, di-tert-butyl-di-sec-butoxysilane, di-tert-butyl-di-tert-butoxysilane, diphenyl-di-ethoxysilane, diphenyl-di-n-propoxysilane, diphenyl-di-isopropoxysilane, diphenyl-di-n-butoxysilane, diphenyl-di-sec-butoxysilane, and diphenyl-di-tert-butoxysilane.

Among those listed above, the following are preferable: dimethyldimethoxysilane, dimethyldiethoxysilane, dimethyldi-isopropoxysilane, dimethyldi-n-butoxysilane, diethyldimethoxysilane, diethyldiethoxysilane, diethyldi-isopropoxysilane, diethyldi-n-butoxysilane, di-n-propyldimethoxysilane, di-n-propyldiethoxysilane, di-n-propyl-di-isopropoxysilane, di-n-propyl-di-n-butoxysilane, di-isopropyldimethoxysilane, di-isopropyldiethoxysilane, di-isopropyl-di-isopropoxysilane, and di-isopropyl-di-n-butoxysilane.

(Molar Fraction of Alkoxysilane Compound in Silane Compound)

The following describes the amount of the alkoxysilane compound used in the silane compound utilized to obtain the siloxane polymer.

It is preferable that the molar fraction of the alkoxysilane compound in the silane compound be 0.5 or above, more preferably in the range of 0.5 to 0.9, and most preferably in the range of 0.6 to 0.9. If the molar fraction of the alkoxysilane compound in the silane compound is in the range above, it becomes possible to lower the dielectric constant of the silica base coating obtained and to improve the mechanical strength and electric properties.

Further, in the case in which the alkoxysilane compound is a mixture of the trialkoxysilane compound and the dialkoxysilane compound, the proportions of the trialkoxysilane compound and the dialkoxysilane compound are not particularly limited, as long as the total molar fraction of the mixture is in the range of 0.5 or above, more preferably in the range of 0.5 to 0.9.

Further, to improve the electric properties, it is especially preferable that the alkoxysilane compound consist of trialkoxysilane only.

Further, regarding the amount of the alkoxysilane compound used, it is preferable that the molar fraction of Si combined with the organic group with respect to the whole silicon contained in the siloxane polymer be 0.5 or above, more preferably in the range of 0.5 to 0.9. This makes it possible to form a silica base coating that is lowered in dielectric constant and improved in mechanical strength and electric properties, in the case in which especially ultraviolet rays are irradiated to the silica base coating made of the composition of the present invention.

(Hydrolysis and Condensation to Obtain Siloxane Polymer)

The following describes the hydrolysis and condensation to obtain the siloxane polymer. The hydrolysis and condensation are carried out by mixing water and catalyst into a solution prepared by dissolving the foregoing silane compound into an organic solvent. It is preferable that the amount of water to be added be in the range of 0.5 mol to 4.0 mol per 1 mol hydrolytic base in the silane compound. The organic solvents that can be used in the hydrolysis and condensation will be described later. Thus, the following only describes the catalyst.

(Kind and Amount of Catalyst Used in Hydrolysis and Condensation)

Examples of the catalyst used in the hydrolysis and condensation include organic acid, inorganic acid, organic base, and inorganic base.

Examples of the organic acid include acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, butyric acid, mellitic acid, arachidonic acid, shikimic acid, 2-ethylhexanoic acid, oleic acid, stearic acid, linoleic acid, linoleic acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, formic acid, malonic acid, sulfonic acid, phthalic acid, fumaric acid, citric acid, and tartaric acid.

Examples of the inorganic acid include hydrochloric acid, nitric acid, sulfuric acid, hydrofluoric acid, and phosphoric acid.

Examples of the organic base include methanolamine, ethanolamine, propanolamine, butanolamine, N-methylmethanolamine, N-ethylmethanolamine, N-propylmethanolamine, N-butylmethanolamine, N-methylethanolamine, N-ethylethanolamine, N-propylethanolamine, N-butylethanolamine, N-methylpropanolamine, N-ethylpropanolamine, N-propylpropanolamine, N-butylpropanolamine, N-methylbutanolamine, N-ethylbutanolamine, N-propylbutanolamine, N-butylbutanolamine, N,N-dimethylmethanolamine, N,N-diethylmethanolamine, N,N-dipropylmethanolamine, N,N-dibutylmethanolamine, N,N-dimethylethanolamine, N,N-diethylethanolamine, N,N-dipropylethanolamine, N,N-dibutylethanolamine, N,N-dimethylpropanolamine, N,N-diethylpropanolamine, N,N-dipropylpropanolamine, N,N-dibutylpropanolamine, N,N-dimethylbutanolamine, N,N-diethylbutanolamine, N,N-dipropylbutanolamine, N,N-dibutylbutanolamine, N-methyldimethanolamine, N-ethyldimethanolamine, N-propyldimethanolamine, N-butyldimethanolamine, N-methyldiethanolamine, N-ethyldiethanolamine, N-propyldiethanolamine, N-butyldiethanolamine, N-methyldipropanolamine, N-ethyldipropanolamine, N-propyldipropanolamine, N-butyldipropanolamine, N-methyldibutanolamine, N-ethyldibutanolamine, N-propyldibutanolamine, N-butyldibutanolamine, N-(aminomethyl)methanolamine, N-(aminomethyl)ethanolamine, N-(aminomethyl)propanolamine, N-(aminomethyl)butanolamine, N-(aminoethyl)methanolamine, N-(aminoethyl)ethanolamine, N-(aminoethyl)propanolamine, N-(aminoethyl)butanolamine, N-(aminopropyl)methanolamine, N-(aminopropyl)ethanolamine, N-(aminopropyl)propanolamine, N-(aminopropyl)butanolamine, N-(aminobutyl)methanolamine, N-(aminobutyl)ethanolamine, N-(aminobutyl)propanolamine, N-(aminobutyl)butanolamine, methoxymethylamine, methoxyethylamine, methoxypropylamine, methoxybutylamine, ethoxymethylamine, ethoxyethylamine, ethoxypropylamine, ethoxybutylamine, propoxymethylamine, propoxyethylamine, propoxypropylamine, propoxybutylamine, butoxymethylamine, butoxyethylamine, butoxypropylamine, butoxybutylamine, methylamine, ethylamine, propylamine, butylamine, N,N-dimethylamine, N,N-diethylamine, N,N-dipropylamine, N,N-dibutylamine, trimethylamine, triethylamine, tripropylamine, tributylamine, tetramethylammoniumhydroxide, tetraethylammoniumhydroxide, tetrapropylammoniumhydroxide, tetrabutylammoniumhydroxide, tetramethylethylenediamine, tetraethylethylenediamine, tetrapropylethylenediamine, tetrabutylethylenediamine, methylaminomethylamine, methylaminoethylamine, methylaminopropylamine, methylaminobutylamine, ethylaminomethylamine, ethylaminoethylamine, ethylaminopropylamine, ethylaminobutylamine, propylaminomethylamine, propylaminoethylamine, propylaminopropylamine, propylaminobutylamine, butylaminomethylamine, butylaminoethylamine, butylaminopropylamine, butylaminobutylamine, pyridine, pyrrole, piperazine, pyrrolidine, piperidine, picoline, morpholine, methylmorpholine, diazabicyclooctane, diazabicyclononane, and diazabicycloundecene.

Examples of the inorganic base include ammonia, sodium hydroxide, potassium hydroxide, barium hydroxide, and calcium hydroxide.

Among those listed above, it is preferable to use an acid catalyst as the catalyst. Examples of preferred organic acid include an organic acid containing a sulfur-containing acid residue, and a carboxylic acid such as formic acid, oxalic acid, fumaric acid, maleic acid, glacial acetic acid, acetic anhydride, propionic acid, and n-butyric acid. Examples of the organic acid containing the sulfur-containing acid residue include organic sulfonic acid, and examples of esters thereof include an organic sulfuric ester and an organic sulfurous ester. Among those listed above, especially the organic sulfonic acid, e.g. the compound represented by general formula (5) below, is preferable

R⁸—SO₃H (5)

(where R⁸ is a hydrocarbon radical that may contain a substituent).

It is preferable that the hydrocarbon radical represented by R⁸ in general formula (5) be a hydrocarbon radical having 1 to 20 carbon atoms. The hydrocarbon radical may be either saturated or unsaturated. Further, the hydrocarbon radical may be in any of straight-chain shape, branched-chain shape, and ring shape.

If the hydrocarbon radical of R⁸ is in the shape of a ring, it is preferable that the hydrocarbon radical be an aromatic hydrocarbon radical such as phenyl group, naphthyl group, and anthryl group, for example. The phenyl group is more preferable. One or plural hydrocarbon radicals having 1 to 20 carbon atoms may be bonded, as a substituent, to an aromatic ring in the aromatic hydrocarbon radical. The hydrocarbon radical as being the substituent on the aromatic ring may be either saturated or unsaturated, and may be in any of straight-chain shape, branched-chain shape, and ring-shape.

The hydrocarbon radical represented by R⁸ may have one or plural substituents. Examples of the substituent include halogen atom such as fluorine atom, sulfonic acid group, carboxyl group, hydroxy group, amino group, and cyano group.

In view of effect of improvement in shape of a bottom part of a resist pattern formed on the silica base coating, it is preferable that the organic sulfonic acid represented by general formula (5) be, especially, nonafluorobutanesulfonic acid, methanesulfonic acid, trifluoromethanesulfonic acid, dodecylbenzenesulfonic acid, or a mixture thereof.

The amount of the catalyst might be adjusted in such a manner that, for example, the concentration in a system of reaction in hydrolysis is in the range of 1 ppm to 1,000 ppm, especially in the range of 5 ppm to 800 ppm.

(Components of Composition Other than Siloxane Polymer)

Lastly, the following describes the components of the composition other than the siloxane polymer. The composition of the present embodiment may contain a hole-forming agent and an alkali-metal-containing compound, in addition to the siloxane polymer.

If the composition contains the alkali-metal-containing compound, the silica base coating made of the composition can be lowered in dielectric constant and improved in electric properties. It also becomes possible to improve the composition in preservation stability and to restrain degassing. Further, if the composition contains a hole-forming agent, it is possible by heating the composition to form holes in the silica base coating made of the composition.

The following describes the alkali-metal-containing compound and the hole-forming agent that can be used in the present invention.

(Kind and Amount of Alkali-Metal-Containing Compound)

Examples of the alkali metal in the alkali-metal-containing compound include sodium, lithium, potassium, rubidium, and caesium. To lower the dielectric constant, it is preferable to use especially rubidium or caesium among those listed above.

Examples of the alkali-metal-containing compound includes organic acid salt of alkali metal, inorganic acid salt of alkali metal, alkoxide of alkali metal, oxide of alkali metal, nitride of alkali metal, halogenide (e.g. chloride, bromide, fluoride, iodide) of alkali metal, and hydroxide of alkali metal.

Examples of preferred organic acids include formic acid, oxalic acid, acetic acid, propionic acid, butyric acid, valeric acid, caproic acid, heptanoic acid, 2-ethylhexanoate, cyclohexanoic acid, cyclohexapropionate, cyclohexane acetic acid, nonanoic acid, malic acid, glutamic acid, leucine acid, hydroxypivalic acid, pivalic acid, glutaric acid, adipic acid, cyclohexanedicarboxylic acid, pimelic acid, suberic acid, ethylbutyric acid, benzoic acid, phenylacetic acid, phenylpropionic acid, hydroxybenzoic acid, caprylic acid, lauric acid, myristic acid, palmitic acid, stearic acid, arachidonic acid, oleic acid, elaidic acid, linoleic acid, and ricinoleic acid.

Examples of preferred inorganic acids include nitric acid, sulfuric acid, hydrochloric acid, carbonic acid, and phosphoric acid.

Examples of preferred alkoxides include methoxide, ethoxide, propoxide, and butoxide, to name a few.

It is preferable that the alkali-metal-containing compound be either an inorganic acid salt of alkali metal or a halogenide of alkali metal, more preferably a nitrate of alkali metal. It is especially preferable that the alkali-metal-containing compound be a rubidium nitrate, among those listed above.

It is preferable that the alkali-metal-containing compound be contained in the range of 1 to 1,000,000 ppm with respect to the solid content (on a SiO₂-mass basis) of the composition, preferably in the range of 10 to 100,000 ppm, and more preferably in the range of 100 to 10,000 ppm. With the alkali-metal-containing compound being in the foregoing range, the effect of the present invention is further improved.

(Kind and Amount of Hole-Forming Agent)

Examples of compounds that can be used as the hole-forming agent include polyalkyleneglycol, a compound in which at least one terminal of polyalkyleneglycol is alkylated, monosaccharide formed of 1 to 22 6-monosaccharide derivatives, disaccharide, polysaccharide or its derivative, and organic peroxide such as benzoyl peroxide that decompose to produce gas.

Among those listed above, the polyalkyleneglycol and the compound in which at least one terminal of the polyalkyleneglycol is alkylated are preferable. It is preferable that the number of carbons in the alkylene base of the polyalkyleneglycol be in the range of 1 to 5, preferably in the range of 1 to 3. Concrete examples include a lower alkyleneglycol, such as polyethyleneglycol and polypropyleneglycol.

The compound in which at least one terminal of the polyalkyleneglycol is alkylated is a compound in which a hydroxy group of at least one terminal is alkoxylated by an alkyl group. It is preferable that the alkyl group utilized to alkoxylate the terminal be in either straight-chain shape or branched-chain shape. Further, it is preferable that the number of carbons in the alkyl group be in the range of 1 to 5, more preferably in the range of 1 to 3. Concretely, a straight-chain alkyl group such as methyl group, ethyl group, and propyl group is preferable.

It is preferable that the mass-average molecular weight (Mw) of the compound in which at least one terminal of the polyalkyleneglycol is alkylated be in the range of 100 to 10,000, more preferably in the range of 200 to 5,000, even more preferably in the range of 400 to 4,000. With the mass-average molecular weight being equal to or below the upper limit of the range mentioned above, it becomes possible to obtain suitable coating properties without deteriorating compatibility in the composition and to improve evenness in film thickness of the silica base coating. Further, with the mass-average molecular weight being equal to or greater than the lower limit of the range mentioned above, it becomes possible to make the silica base coating more porous and to lower the dielectric constant.

It is preferable that the amount of the hole-forming agent used be in the range of 25 to 200% by weight, more preferably in the range of 30 to 100% by weight, with respect to the solid content (on a SiO₂-mass basis) in the composition. Use of the hole-forming agent within the range mentioned above allows the silica base coating to be reduced in dielectric constant.

The hole-forming agent may be used alone or in combination of two or more kinds.

(Kind and Amount of Organic Solvent)

The composition of the present embodiment may further contain water or an organic solvent. The same organic solvent as that discussed above and utilized to dissolve the silane compound may be used. Concre examples of the organic solvent include: aliphatic hydrocarbon base solvent such as n-pentane, isopentane, n-hexane, isohexane, n-heptane, isoheptane, 2,2,4-trimethylpentane, n-octane, isooctane, cyclohexane, and methylcyclohexane; aromatic hydrocarbon base solvent such as benzene, toluene, xylene, ethylbenzene, trimethylbenzene, methylethylbenzene, n-propylbenzene, isopropylbenzene, diethylbenzene, isobutylbenzene, triethylbenzene, di-isopropylbenzene, n-amylnaphthalene, and trimethylbenzene; monohydric alcohol base solvent such as methanol, ethanol, n-propanol, isopropanol, n-butanol, isobutanol, sec-butanol, tert-butanol, n-pentanol, isopentanol, 2-methylbutanol, sec-pentanol, tert-pentanol, 3-methoxybutanol, n-hexanol, 2-methylpentanol, sec-hexanol, 2-ethylbutanol, sec-heptahol, 3-heptahol, n-octanol, 2-ethylhexanol, sec-octanol, n-nonyl alcohol, 2,6-dimethyl-4-heptahol, n-decanol, sec-undecyl alcohol, trimethylnonyl alcohol, sec-tetradecyl alcohol, sec-heptadecyl alcohol, phenol, cyclohexanol, methylcyclohexanol, 3,3,5-trimethylcyclohexanol, benzyl alcohol, phenylmethylcarbinol, diacetone alcohol, and cresol; polyhydric alcohol base solvent such as ethyleneglycol, 1,2-propyleneglycol, 1,3-butyleneglycol, pentane-2,4-diol, 2-methylpentane-2,4-diol, hexane-2,5-diol, heptane-2,4-diol, 2-ethylhexane-1,3-diol, diethyleneglycol, dipropyleneglycol, triethyleneglycol, tripropyleneglycol, and glycerin; ketone base solvent such as acetone, methylethylketone, methyl-n-propylketone, methyl-n-butylketone, diethylketone, methyl-isobutylketone, methyl-n-pentylketone, ethyl-n-butylketone, methyl-n-hexylketone, di-isobutylketone, trimethylnonanone, cyclohexanone, methylcyclohexanone, 2,4-pentanedione, acetonyl alcohol, acetone, diacetonyl alcohol, acetophenone, and fenchone; ether base solvent such as ethylether, isopropylether, n-butylether, n-hexylether, 2-ethylhexylether, ethyleneoxide, 1,2-propyleneoxide, dioxolan, 4-methyldioxolan, dioxane, dimethyldioxane, ethyleneglycolmonomethylether, ethyleneglycolmonoethylether, ethyleneglycoldiethylether, ethyleneglycolmono-n-butylether, ethyleneglycolmono-n-hexylether, ethyleneglycolmonophenylether, ethyleneglycolmono-2-ethylbutylether, ethyleneglycoldibutylether, diethyleneglycolmonomethylether, diethyleneglycolmonoethylether, diethyleneglycoldiethylether, diethyleneglycolmono-n-butylether, diethyleneglycoldi-n-butylether, diethyleneglycolmono-n-hexylether, ethoxytriglycol, tetraethyleneglycoldi-n-butylether, propyleneglycolmonomethylether, propyleneglycolmonoethylether, propyleneglycolmonopropylether, propyleneglycolmonobutylether, dipropyleneglycolmonomethylether, dipropyleneglycolmonoethylether, tripropyleneglycolmonomethylether, tetrahydrofuran, and 2-methyltetrahydrofuran; ester base solvent such as diethylcarbonate, methyl acetate, ethyl acetate, γ-butyrolactone, γ-valerolactone, n-propyl acetate, isopropyl acetate, n-butyl acetate, isobutyl acetate, sec-butyl acetate, n-pentyl acetate, sec-pentyl acetate, 3-methoxybutyl acetate, methylpentyl acetate, 2-ethylbutyl acetate, 2-ethylhexyl acetate, benzyl acetate, cyclohexyl acetate, methylcyclohexyl acetate, n-nonyl acetate, methyl acetoacetate, ethyl acetoacetate, ethyleneglycolmonomethylether acetate, ethyleneglycolmonoethylether acetate, diethyleneglycolmonomethylether acetate, diethyleneglycolmonoethylether acetate, diethyleneglycolmono-n-butylether acetate, propyleneglycolmonomethylether acetate, propyleneglycolmonoethylether acetate, propyleneglycolmonopropylether acetate, propyleneglycolmonobutylether acetate, dipropyleneglycolmonomethylether acetate, dipropyleneglycolmonoethylether acetate, glycol diacetate, methoxytriglycol acetate, ethyl propinate, n-butyl propinate, isoamyl propinate, diethyl oxalate, di-n-butyl oxalate, methyl lactate, ethyl lactate, n-butyl lactate, n-amyl lactate, diethyl malonate, dimethyl phthalate, and diethyl phthalate; nitrogen-containing solvent such as N-methylformamide, N,N-dimethylformamide, N,N-diethylformamide, acetamide, N-methylacetamide, N,N-dimethylacetamide, N-methylpropion amide, and N-methylpyrrolidone; sulfur-containing solvent such as dimethyl sulfide, diethyl sulfide, thiophene, tetrahydrothiophene, dimethylsulfoxide, sulfolane, and 1,3-propanesultone. Those listed above may be used alone or in combination of two or more kinds.

The amount of the organic solvent to be used is not particularly limited, but it is preferable that the concentration of the siloxane polymer in the composition be in the range of approximately 0.1 to 20% by weight. It is more preferable that the concentration be adjusted so as to be in the range of approximately 0.5 to 10% by weight. Use of the organic solvent within the above-mentioned range of concentration allows an applied film to have a thickness in a suitable range, and the preservation stability can be improved further.

Further, regarding the organic solvent, it is preferable that an organic solvent that dissolves the alkali metal compound, especially a hydrophilic organic solvent, be contained. Examples of the hydrophilic organic solvent include a lower alcohol such as acetone, methanol, ethanol, n-propanol, isopropanol, n-butanol, and isobutanol. It is preferable that the hydrophilic organic solvent be in the range of approximately 1 to 100% by weight, more preferably in the range of approximately 5 to 30% by weight, with respect to the whole organic solvent used.

(Additional Notes)

Surfactant may be added to the composition of the present embodiment to improve the coating properties and to prevent striation. Examples of the surfactant include nonionic surfactant, anionic surfactant, cationic surfactant, amphoteric surfactant, silicon-series surfactant, polyalkyleneoxide-series surfactant, and poly(meth)acrylate-series surfactant.

### Embodiment 2

(Forming Silica Base Coating)

The following describes Embodiment 2, discussing a method of forming a silica base coating by use of the composition of Embodiment 1. Note that the wordings used in Embodiment 1 imply the same meanings in the present embodiment.

It is preferable that the method include the following three steps: (1) an application step; (2) a drying step; and (3) an irradiation step. The following describes the respective steps.

Note that the steps of preparing and producing the composition are carried out prior to the application step. Specifically, a molar fraction of an alkoxysilane compound in a silane compound containing an alkoxysilane compound is adjusted during the steps. Then, the silane compound thus prepared is hydrolyzed in a solution and condensed to obtain a siloxane polymer, and a composition containing the siloxane polymer is produced.

Conventional publicly-known processes may be employed as the foregoing steps, and the compounds to be employed and the like are already described in Embodiment 1. Thus, descriptions thereof are omitted in the present embodiment.

(Application Step)

The following describes the application step. In the application step, the composition for forming a coating is applied to a base material.

Examples of the base material to which the composition can be applied include semiconductor, glass, ceramic, and metal.

Conventional publicly-known methods may be employed to apply the composition in the application step. Concrete examples of the conventional publicly-known methods include spin-coating, dipping, and roller-blading. For example if the composition is to be used as the interlayer insulating films in semiconductor devices, it is preferable in view of film formability and film evenness to employ the spin-coating to apply the composition. Concretely, it is preferable that the composition be applied to a substrate by spinning at 500 to 5,000 rotations/minute, preferably at 1,000 to 3,000 rotations/minute.

The thickness of the applied film is not particularly limited, and may be set as appropriate according to the intended use of the coating to be formed.

(Drying Step)

The following describes the drying step. In the drying step, the composition applied to the base material is dried at 300° C. or below.

The upper limit of this drying temperature is set to 300° C., preferably 250° C., so that it becomes possible to dry the composition, and at the same time, retard the hydrolysis of the composition. The lower limit of the drying temperature is not particularly limited, but it is preferable that the lower limit be 50° C., more preferably 80° C. This makes it possible to eliminate an organic solvent having a low boiling point and to facilitate the drying.

It is preferable that the drying step be a combination of two stages in which the drying is carried out at different temperatures. The number of stages in the drying step is not particularly limited, but approximately two to three stages are preferable in view of the work required in the drying step.

For example if the drying step includes two stages, it is preferable that the temperature in the first stage be approximately 50° C. to 200° C. and the temperature in the second step be approximately 100° C. to 300° C. If the drying step includes three stages, it is preferable that the temperature in the first stage be approximately 50° C. to 150° C., the temperature in the second stage be approximately 100° C. to 250° C., and the temperature in the third stage be approximately 150° C. to 300° C.

Carrying out the drying step in multi-stages makes it possible to dry the composition, while the stress on the composition applied to the substrate is reduced and cracks are restrained.

A drying period in the drying step is not particularly limited, but a period of approximately 1 to 5 minutes for each temperature is preferable.

(Irradiation Step)

The following describes the irradiation step. In the irradiation step, the composition thus dried is heated at 350° C. or a higher temperature, and at the same time, ultraviolet rays are irradiated.

In the present Specification, this process of irradiating the ultraviolet rays concurrently with the heating is referred to as a UV annealing. In other words, the irradiation step in the present invention implies the UV annealing.

It is preferable that a heating temperature of the UV annealing be in the range of 350° C. to 450° C., more preferably in the range of 350° C. to 400° C.

An excimer lamp, for example, may be used as a source of ultraviolet rays in the UV annealing. It is preferable that the wavelength of the ultraviolet rays be in the range of 120 nm to 400 nm, more preferably in the range of 120 nm to 200 nm, and most preferably 172 nm.

The conditions of the UV annealing are set so as to be in the above-mentioned ranges of the temperatures and the wavelengths of ultraviolet rays, whereby an organic group bonded to Si in the siloxane polymer is separated and then discharged from the silica base coating. This would make it possible to make the silica base coating porous so that the dielectric constant improves. Further, the heating during the irradiation of ultraviolet rays would facilitate the discharging of the organic group that is separated. Further, a part of Si of the organic group that is separated would form a Si—O—Si bonding so that the skeleton thereof would become robust and the mechanical strength would improve. At the same time, the silica base coating become dense, and hygroscopic properties improve, so that it would become possible to improve the electric properties.

Further, it is preferable that a pressure in the atmosphere where the dried composition is to be placed during the UV annealing be in the range of 0.2 Pa to 0.6 Pa. It is preferable that the period of the UV annealing be in the range of 30 seconds to 7 minutes, more preferably in the range of 3 minutes to 5 minutes, most preferably 3 minutes. Further, it is preferable that the intensity of ultraviolet rays be in the range of 5 mW/cm² to 50 mW/cm². Setting the UV annealing conditions within the foregoing ranges makes it possible to form a silica base coating that is lowered in dielectric constant and improved in mechanical strength and electric properties.

### Embodiment 3

The following describes Embodiment 3 regarding a silica base coating that is made of the composition of Embodiment 1 by the method of Embodiment 2.

The wordings used in Embodiments 1 and 2 imply the same meanings in the present embodiment.

Concrete use of the silica base coating of the present embodiment is not particularly limited, but the silica base coating is suitably utilized to form the following films: interlayer insulating films for semiconductor devices such as LSI, system LCD, DRAM, SDRAM, RDRAM, and D-RDRAM; protection films such as surface coating films for semiconductor devices; interlayer insulating films of multi-layer wiring boards; and protection films and insulation preventing films for liquid crystal display devices.

The foregoing concretely describes the present invention on the basis of the embodiments. The present invention is not limited to the description of the embodiments above, but may be altered by a skilled person within the scope of the claims. An embodiment based on a proper combination of technical means disclosed in different embodiments is encompassed in the technical scope of the present invention.

The following provide Examples to describe embodiments of the present invention in further detail. The following Examples are certainly not to limit the present invention, and the details may be altered in various ways.

### EXAMPLES

### Example 1

### Preparation of Composition for Forming a Coating

First, 74.10 g (0.5 mol) tetramethoxysilane and 66.30 g (0.5 mol) methyltrimethoxysilane were dissolved in 186.75 g acetone and stirred. In the present Example, the molar fraction of the methyltrimethoxysilane with respect to the whole silane compound was 0.5. Then, solution of a mixture of 122.85 g water and 10.4 μL nitric acid having a concentration of 60% by weight was dropped while being stirred slowly, and then was stirred for five hours, whereby a siloxane polymer solution was obtained.

Thereafter, 6.3 g polyalkyleneoxide having weight-average molecular weight of 1,000 was added to 100 g siloxane polymer solution, and then 3.90 g aqueous solution containing 0.1% by weight rubidium nitrate was added. Then, 79.7 g acetone and 243.86 g isopropyl alcohol were added and stirred, whereby a composition with the siloxane polymer having a concentration adjusted to 3% by weight was obtained.

(Forming Silica Base Coating)

The composition was applied to an 8-inch silicon wafer by spin-coating and baked by use of a hot plate. A heating process in the baking was carried out at 80° C. for one minute, then at 150° C. for one minute, and then at 250° C. for one minute. Thereafter, the UV annealing was carried out by use of a UV annealing apparatus (manufactured by the Semiconductor Process Laboratory) under the following conditions, whereby a silica base coating having a thickness of approximately 230 nm was obtained.

(Conditions of UV Annealing)

(i) Source of ultraviolet rays: deuterium lamp

Wavelength of ultraviolet rays: 172 nm

Intensity of ultraviolet rays: 22 mW/cm2

Distance of irradiation of ultraviolet rays: 100 mm

(ii) Heating temperature: 350° C.
(iii) Processing pressure: 0.2 Pa
(iv) Time of processing: 3 minutes or 5 minutes

### Example 2

First, 59.28 g (0.4 mol) tetramethoxysilane and 79.56 g (0.6 mol) methyltrimethoxysilane were dissolved into 191.82 g acetone and stirred. In the present Example, the molar fraction of the methyltrimethoxysilane with respect to the whole silane compound was 0.6. Then, a solution of a mixture of 119.34 g water and 10.1 μL nitric acid having a concentration of 60% by weight was dropped while being stirred slowly, and then was stirred for five hours, whereby a siloxane polymer solution was obtained. The subsequent processes were carried out in the same manner as in Example 1 to obtain a silica base coating.

### Comparative Example 1

First, 88.92 g (0.6 mol) tetramethoxysilane and 53.04 g (0.4 mol) methyltrimethoxysilane were dissolved into 181. 68 g acetone and stirred. In the present Example, the molar fraction of the methyltrimethoxysilane with respect to the whole silane compound was 0.4. Then, a solution of a mixture of 126.36 g water and 10.7 μL nitric acid having a concentration of 60% by weight was dropped while being stirred slowly, and then was stirred for five hours, whereby a siloxane polymer solution was obtained. The subsequent processes were carried out in the same manner as in Example 1 to obtain a silica base coating.

(How Silica Base Coating was Evaluated)

The respective silica base coatings of Examples 1 and 2 and Comparative Example 1 were evaluated by measuring their dielectric constants, leak currents, and mechanical strengths.

The leak currents were measured to evaluate the electric properties of the respective silica base coatings. The mechanical strengths were evaluated by measuring moduli of elasticity. The “modulus of elasticity” in the present Specification means the Young's modulus. The Young's modulus is a ratio of a stretch in a solid body, or a compression stress, and a distortion in that direction. The following describes how the dielectric constants, the leak currents, and the moduli of elasticity were measured.

(How the Dielectric Constant and the Leak Current were Measured)

The dielectric constant and the leak current were measured by use of a mercury probe type CV, IV measuring device (SSM495, manufactured by SSM Japan). Further, the leak current was measured at 1 MV/cm and 2 MV/cm.

(How the Moduli of Elasticity were Measured)

The moduli of elasticity (GPa) were measured by use of Nano Indentor XP-SA2 manufactured by MST.

### Comparative Example 2

A silica base coating was formed in the same manner as in Example 1, except that baking at 350° C. for 30 minutes was carried out in place of the UV annealing. Then, the dielectric constant and the modulus of elasticity of the silica base coating were measured. The dielectric constant and the modulus of elasticity were measured in the same manner as in Examples 1 and 2 and Comparative Example 1, using the same apparatus and same method.

### Comparative Example 3

A silica base coating was formed in the same manner as in Example 2, except that baking at 350° C. for 30 minutes was carried out in place of the UV annealing. Then, the dielectric constant and the modulus of elasticity of the silica base coating were measured. The dielectric constant and the modulus of elasticity were measured in the same manner as in Examples 1 and 2 and Comparative Example 1, using the same apparatus and method.

(Evaluation Result)

Table 1 shows respective dielectric constants, leak currents, and moduli of elasticity of Examples 1 and 2 and Comparative Examples 1 to 3 in the case in which the UV annealing was carried out for a period of 3 to 5 minutes. For the purpose of convenience, the measurement results of Comparative Examples 2 and 3 are shown under the section of the UV annealing period of 3 minutes, although the UV annealing was carried out in neither of Comparative Examples 2 and 3.

TABLE 1

| | | UV | | | | | |
|---|---|---|---|---|---|---|---|
| | | ANNEALING | | | | | |
| | | PERIOD | | | COMPARATIVE | COMPARATIVE | COMPARATIVE |
| | | (min) | EXAMPLE 1 | EXAMPLE 2 | EXAMPLE 1 | EXAMPLE 2 | EXAMPLE 3 |
| DIELECTRIC | | 3 | 2.28 | 2.16 | 2.66 | 2.41 | 2.31 |
| CONSTANT | | 5 | 2.34 | 2.21 | 2.85 | — | — |
| LEAK | 1 MV | 3 | 3.6 × 10⁻¹⁰ | 2.0 × 10⁻¹⁰ | 3.1 × 10⁻⁸ | 3.5 × 10⁻¹⁰ | 1.0 × 10⁻¹⁰ |
| CURRENT | 2 MV | | 6.4 × 10⁻⁹ | 1.9 × 10⁻⁹ | 1.1 × 10⁻⁶ | 8.9 × 10⁻⁹ | 2.6 × 10⁻⁹ |
| (A/cm2) | 1 MV | 5 | 1.2 × 10⁻⁹ | 2.4 × 10⁻¹¹ | 1.1 × 10⁻⁷ | — | — |
| | 2 MV | | 1.1 × 10⁻⁸ | 7.9 × 10⁻¹⁰ | 2.4 × 10⁻⁵ | — | — |

| | | | | | | |
|---|---|---|---|---|---|---|
| MODULUS OF | 3 | 5.73 | 5.57 | 6.57 | 4.10 | 3.43 |
| ELASTICITY | 5 | 6.4 | 6.21 | 7.15 | — | — |
| (Gpa) | | | | | | |

The results of Examples 1 and 2 and Comparative Examples 2 and 3 show that carrying out the UV annealing reduces the dielectric constants and improves the moduli of elasticity. The results also show that the effect of reduction in the leak currents by the UV annealing is significant when the molar fraction of the methyltrimethoxysilane, which is an alkoxysilane compound, is 0.6 or above.

Further, the results of Examples 1 and 2 and Comparative Example 1 show that increasing the molar fraction of the methyltrimethoxysilane, which is an alkoxysilane compound, reduces the dielectric constants of the silica base coatings and the leak currents. The results also show that the effect further improves especially when the molar fraction is 0.5 or above.

(Improvement in Dielectric Constant and Modulus of Elasticity by UV Annealing)

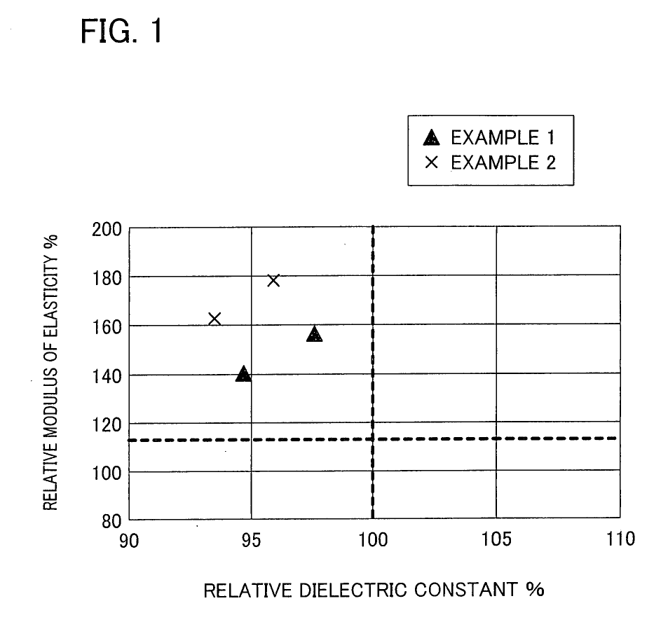

FIG. 1 shows results regarding improvement in dielectric constant and modulus of elasticity by the UV annealing. FIG. 1 is a graph showing a relative dielectric constant and a relative modulus of elasticity of Example 1 with respect to those of Comparative Example 2, and a relative dielectric constant and a relative modulus of elasticity of Example 2 with respect to those of Comparative Example 3. The horizontal axis of the graph represents a relative dielectric constant (%), and the vertical axis of the graph represents a relative modulus of elasticity (%). Specifically, FIG. 1 shows, in percentage, how much Example 1 improves in dielectric constant and modulus of elasticity compared with Comparative Example 3, and how much Example 2 improves in dielectric constant and modulus of elasticity compared with Comparative Example 3.

As shown in FIG. 1, Example 1 is reduced in dielectric constant to approximately 95% to 97% and improved in modulus of elasticity to approximately 140% to 160%, compared with Comparative Example 2. Further, Example 2 is reduced in dielectric constant to 94% to 96% and improved in modulus of elasticity to approximately 160% to 180%, compared with Comparative Example 3. The foregoing shows that carrying out the UV annealing allows reduction in dielectric constant and improvement in modulus of elasticity.

With the composition of the present invention, it is possible to form a silica base coating that is reduced in dielectric constant and improved in mechanical strength and electric properties by, for example, irradiating ultraviolet rays and heating. This is an advantage.

The silica base coating made of the composition of the present invention can be used suitably as the insulating films and the protection films. Concrete examples of the insulating films and protection films include: interlayer insulating films for semiconductor devices such as LSI, system LCD, DRAM, SDRAM, RDRAM, and D-RDRAM; protection films such as surface coating films for semiconductor devices; interlayer insulating films for multi-layer wiring boards; and protection films and insulation preventing films for liquid crystal display devices.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A composition for forming a coating, the composition containing a siloxane polymer obtained by hydrolyzing and condensing a silane compound containing an alkoxysilane compound represented by general formula (1) below
R¹ₙSi(OR²)₄₋ₙ (1)
(where R¹ represents an organic group having 1 to 20 carbon atoms, R² represents an alkyl group having 1 to 4 carbon atoms, and n represents either 1 or 2),
the silane compound containing the alkoxysilane compound at a molar fraction of 0.5 or above.

2. The composition of claim 1, wherein the silane compound contains tetraalkoxysilane.

3. The composition of claim 1, wherein the alkoxysilane compound represented by general formula (1) contains alkyltrialkoxysilane.

4. The composition of claim 1, wherein the alkoxysilane compound represented by general formula (1) contains dialkyltrialkoxysilane.

5. The composition of claim 1, containing a siloxane polymer in the range of 0.1% by weight to 20% by weight.

6. The composition of claim 1, further containing a hole-forming agent.

7. The composition of claim 1, further containing an alkali-metal-containing compound.

8. The composition of claim 7, wherein the alkali-metal-containing compound contains an alkali metal selected from a group consisting of sodium, lithium, potassium, rubidium, and caesium.

9. The composition of claim 7, wherein the alkali-metal-containing compound is selected from a group consisting of a nitrate of alkali metal, a sulfate of alkali metal, a carbonate of alkali metal, an oxide of alkali metal, a chloride of alkali metal, a bromide of alkali metal, a fluoride of alkali metal, an iodide of alkali metal, and a hydroxide of alkali metal.

10. A coating, obtained by drying, at 300° C. or below, a composition for forming a coating, and then irradiating an ultraviolet ray, the composition containing a siloxane polymer obtained by hydrolyzing and condensing a silane compound containing an alkoxysilane compound represented by general formula (1) below
R¹ₙSi(OR²)₄₋ₙ (1)
(where R¹ represents an organic group having 1 to 20 carbon atoms, R² represents an alkyl group having 1 to 4 carbon atoms, and n represents either 1 or 2),
the silane compound containing the alkoxysilane compound at a molar fraction of 0.5 or above.

11. A composition for forming a coating, wherein:
the composition contains a siloxane polymer obtained by hydrolyzing and condensing a silane compound containing an alkoxysilane compound represented by general formula (1) below
R¹ₙSi(OR²)₄₋ₙ (1)
(where R¹ represents an organic group having 1 to 20 carbon atoms, R² represents an alkyl group having 1 to 4 carbon atoms, and n represents an integer in the range of 1 to 2); and
a molar fraction of Si combined with the organic group is 0.5 or above with respect to all silicon constituting the siloxane polymer.

12. The composition of claim 11, wherein the silane compound contains tetraalkoxysilane.

13. The composition of claim 11, wherein the alkoxysilane compound represented by general formula (1) contains alkyltrialkoxysilane.

14. The composition of claim 11, wherein the alkoxysilane compound represented by general formula (1) contains dialkyltrialkoxysilane.

15. The composition of claim 11, containing the siloxane polymer in the range of 0.1% by weight to 20% by weight.

16. The composition of claim 11, further containing a hole-forming agent.

17. The composition of claim 11, further containing an alkali-metal-containing compound.

18. The composition of claim 17, wherein the alkali-metal-containing compound contains an alkali metal selected from a group consisting of sodium, lithium, potassium, rubidium, and caesium.

19. The composition of claim 17, wherein the alkali-metal-containing compound is selected from a group consisting of a nitrate of alkali metal, a sulfate of alkali metal, a carbonate of alkali metal, an oxide of alkali metal, a chloride of alkali metal, a bromide of alkali metal, a fluoride of alkali metal, an iodide of alkali metal, and a hydroxide of alkali metal.

20. A coating, wherein:
the coating is obtained by drying, at 300° C. or below, a composition for forming a coating, and then irradiating an ultraviolet ray, the composition containing a siloxane polymer obtained by hydrolyzing and condensing a silane compound containing an alkoxysilane compound represented by general formula (1) below
R¹ₙSi(OR²)₄₋ₙ (1)
(where R¹ represents an organic group having 1 to 20 carbon atoms, R² represents an alkyl group having 1 to 4 carbon atoms, and n represents an integer in the range of 1 to 2); and
a molar fraction of Si combined with the organic group is 0.5 or above with respect to all silicon constituting the siloxane polymer.
